(19) United States
(12) Patent Application Publication
(10) Pub. No.: US 2007/0164579 A1
(43) Pub. Date: Jul. 19, 2007

(54) Server's tray with enclosed drawers and removable cash bank

(76) Inventor: Elizabeth Suzanne Pike, Danville, KY (US)

Correspondence Address: ELIZABETH S. PIKE, 216 N. FIRST STREET, DANVILLE, KY, 40422, US

(21) Appl. No.: 11/654,132

(22) Filed: Jan. 17, 2007

Related U.S. Application Data
(60) Provisional application No. 60/758,883, filed on Jan. 17, 2006.

(51) Int. Cl. A47B 31/04; G06F 15/02

(52) U.S. Cl. 294/144; 235/1 D

(57) ABSTRACT

A server's tray with enclosed sliding drawers (1B). The left side drawer has an open compartment for storage (7). The right side drawer has a landing for the means of inserting a removable cash bank (7). Said drawers slide left to right via a slotted track (5). Removable cash bank (12) has molded interior alcoves for coin monies (8) and paper money (10). Cash bank is joined together with hinges (FIG. 8).

### CROSS-REFERENCE TO RELATED APPLICATIONS

This application claims the benefit of provisional patent application Ser. No. 600758,883, filed 2006 Jan. 17 by present inventor.

### FEDERALLY SPONSERED SEARCH

Not Applicable

### SEQUENCE LISTING OR PROGRAM

Not Applicable

### BACKGROUND OF INVENTION

1. Field of Invention

This invention relates to food and beverage server's tray, specifically to enclosed Drawers and inboard removable cash bank.

2. Prior Art

This invention relates to service trays employed by waiters and waitresses in cocktail lounges, casinos and food service industries. Such trays are used to carry beverages and food.

The existing server's trays are made from hard, molded and non-transparent plastic. Typically, trays are rectangular, oval or round shapes and slightly concaved. Server's are encumbered with the burden of making money transaction whilst serving beverages and or food.

Thus, the space available upon the server's working tray is overwhelmed with change making devices, pens, order pads and money tips. Hence, the working space upon the tray is limited and leaves less room for the server to carry the customer's purchased goods.

Thereafter, inventors created several types of server's trays, cash banks and tip holders to allow for better efficiency for servers. U.S. Pat. No. 2,948,391 to McLeod (1960) discloses a serving tray with a cash receptacle; however, the cash receptacle device is located on top of the surface area of the tray eliminating working space. U.S. Pat. Des. 296,949 to Warwicker (1988) employs a cash box tray with open compartments and a secondary drawer that is attached to the bottom of the tray and slides outward. Warwicker's allows for many various items to be carried upon and within the tray, however, the open area of the top part of the tray does not afford the portability of beverages or food. U.S. Pat. No. 5,016,262 to Cushing (1991) demonstrates a portable cash box for carrying money and making change in addition to a signaling device to gauge the number of times the instrument is opened. Cushings portable design is meant to set upon the server's tray and in the process, eliminating more working space for the server's product. Lastly, U.S. Pat. No. 4,413,745 to Stroud (1983) demonstrates a complicated construction of a receptacle that is attached to the outside rim of the server's tray by means of a “plurality of clips” with open compartments; the outside compartments secured by clips, accommodates items such as napkins and swizzle sticks, therefore does not allow for money transaction and is grossly unbalanced weight for the server.

Although trays that allow for portable, attached or concaved accommodations for money transactions and various server accruements, valuable working space is eliminated and thus, renders the server less efficient and disorganized.

Several types of thin, illuminated and slotted trays allow for transaction of credit card processes, for example; U.S. Pat. No. 4,679,691 to Halloran (1987) demonstrates a three sided tip tray which has a transparent top under which a sliding tray displays messages etc. Whilst space is available for product, once again the available space will be consumed by cash boxes and alike.

U.S. Pat. Des. 332,685 (1993) to Edwards designs a lighted gratuities/tip tray which only allows for credit card transactions. U.S. Pat. No. 5,813,748 to Maxymych (1998) comprise a hinged lid tray with a window and illumination. Maxymch's tray is specifically for credit card transactions and money verification, hence beverage service and such are not appropriate for this invention. Finally, U.S. Pat. Des. 317,671 to Skags, Thomas, Danis & Melean (1991) is a thin coin tray and is difficult comprehend it's function. Said invention appears to have an area where coins can be deposited, however, not accessible nor applicable for money transactions. Moreover, the aforementioned trays are specifically for paper transactions or coin and not in the service of money transactions and beverage or food delivery.

Therefore, all the server trays hereto known suffer from a number of disadvantages:
(a) Working space on top of servers tray is encumbered by various accruements. Such as cash banks, tip jars, swizzle sticks, order pads and pencils or pens.
(b) Lack of available working space for saleable product.
(c) Loss of security for money transactions: Cash banks, tip jars and alike are easily stolen or lost.
(d) Inefficiency in service: Transactions take longer with less working space.
(e) Customer satisfactions declines: Customers have to wait longer for drink orders.
(f) Less product being sold per round/order: Due to less working space, there is less space on server tray for drinks and or food.
(g) Profit margin decreases.

3. Object and Advantages

Accordingly, several objects and advantages of the present invention are:
(a) Enclosed drawers organize server's cash bank, note pad, pens, tips and alike.
(b) Working space on top of server's tray is increased: Enclosed drawers house money, pens, notepads and alike, thus freeing space for more product.
(c) Enclosed drawers are secure within the tray and less apt to theft or loss. Additionally, cash bank is removable for portability and security.
(d) Enclosed drawers slide left to right: Server can easily access cash bank or storage drawer without disturbing product on top of serving tray.
(e) Customer satisfaction increases. More customers are being served per round or order.
(f) Increased working space on top of servers tray allows for more drinks to be carried per round or order. Thus affords more customers to be served within a given time.
(g) Profit margin increases. More saleable goods being sold per round or order due to increased space upon tray and efficiency.

### SUMMARY

In accordance to the present invention a server's tray comprises enclosed sliding drawers, left to right which employ a removable cash bank and an open drawer available for the server's, pens, tips and alike.

### DRAWINGS—FIGURES

In the drawings, closely related figures have the same number but different alphabetic suffixes.

FIGS. 1A to 1D show various aspects of the server tray in an assembled state.

FIG. 2 shows the skeleton of the tray with sliding track for drawers and peg holes for top of tray connection.

FIG. 3 shows top of tray that inserts into pegs of bottom of tray. (FIG. 2)

FIG. 4 shows left open space drawer and landing of right side drawer.

FIG. 5 shows bottom of removable cash bank with concave areas for coin, paper monies and slots for assembly.

FIG. 6 shows top part of removable cash bank with exterior surface concave with embedded notches for notepad insertion.

FIG. 7 shows interior of top part of removable cash bank. (FIG. 6)

FIG. 8 shows exterior hinges to join top and bottom parts (FIG. 6 & 7) of removable cash bank.

FIG. 9 shows interior view of assembled removable cash bank.

### DRAWINGS—Reference Numerals

1 fully assembled and closed tray

2 enclosed right side drawer with removable cash bank

3 interior views of enclosed drawers and removable cash bank

4 left drawer and right drawer with removable cash bank on slotted tracks

5 skeleton of interior tray and slotted track.

6 top of tray

7 left drawer and landing of right side drawer

8 bottom interior part of removable cash bank

9 top interior of removable cash bank

10 top exterior of removable cash bank

11 exterior back hinge assembly of removable cash bank

12 fully assembled interior of removable cash bank

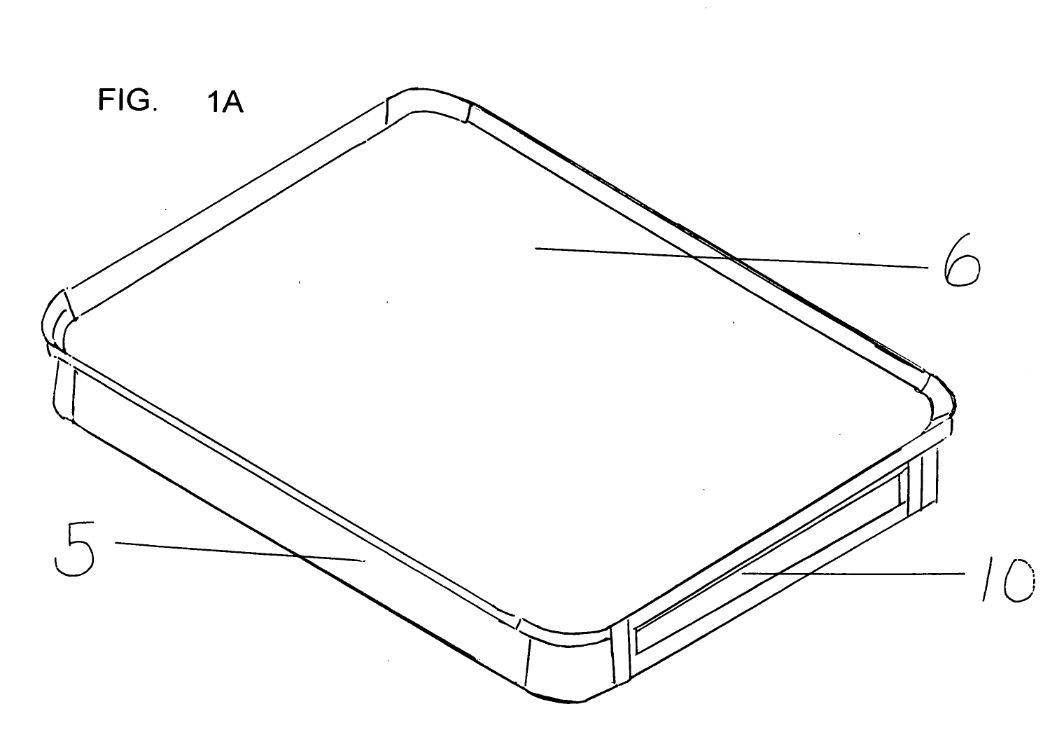

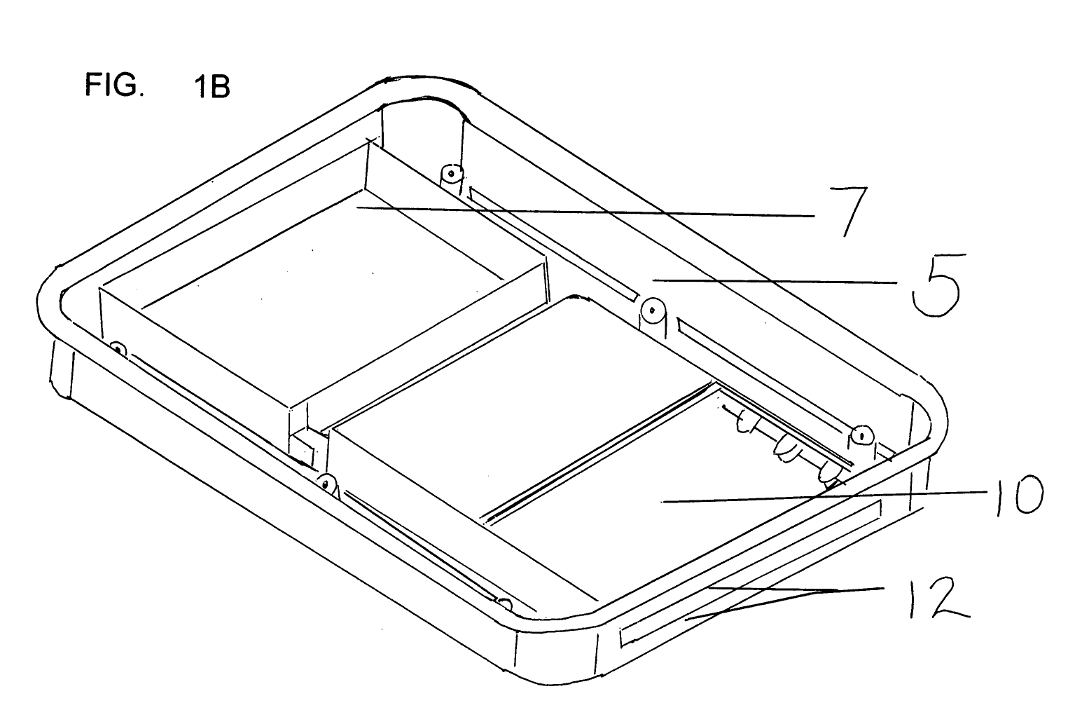

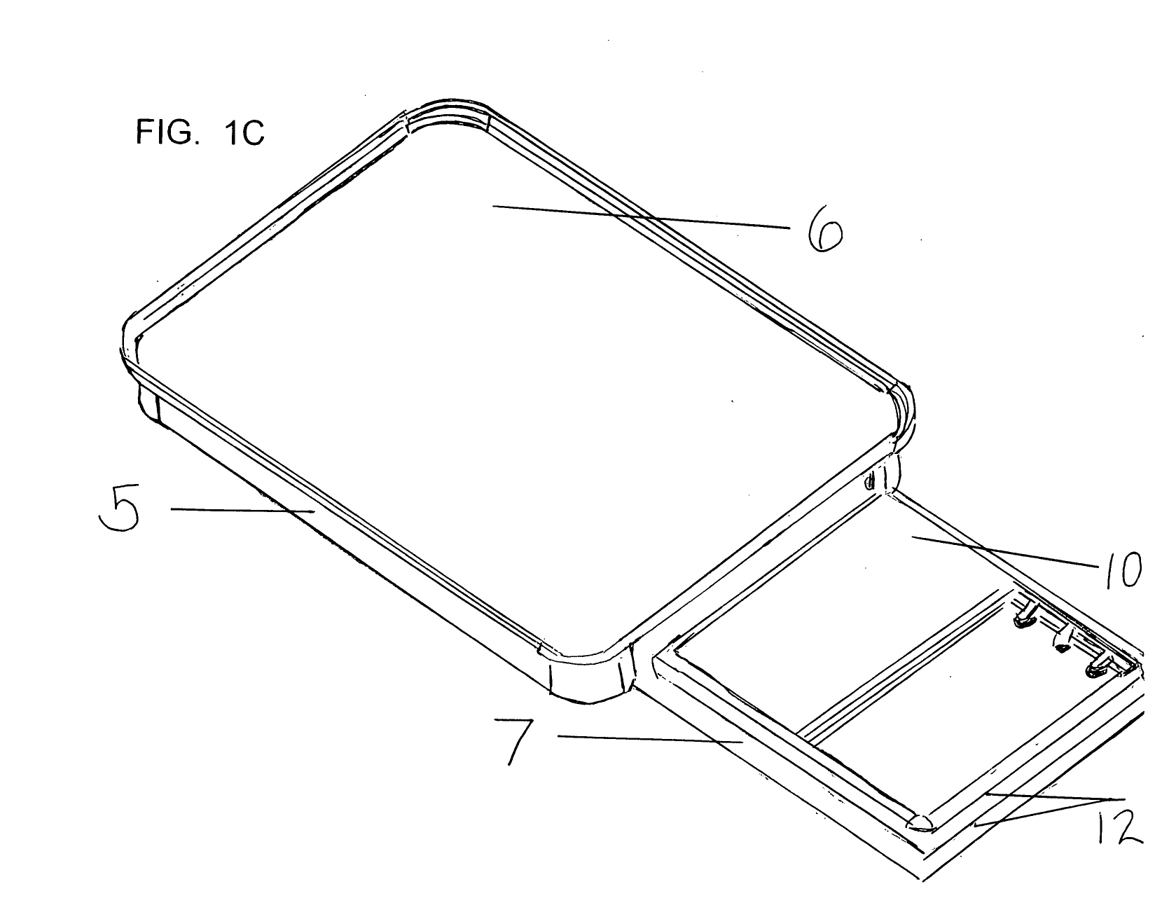

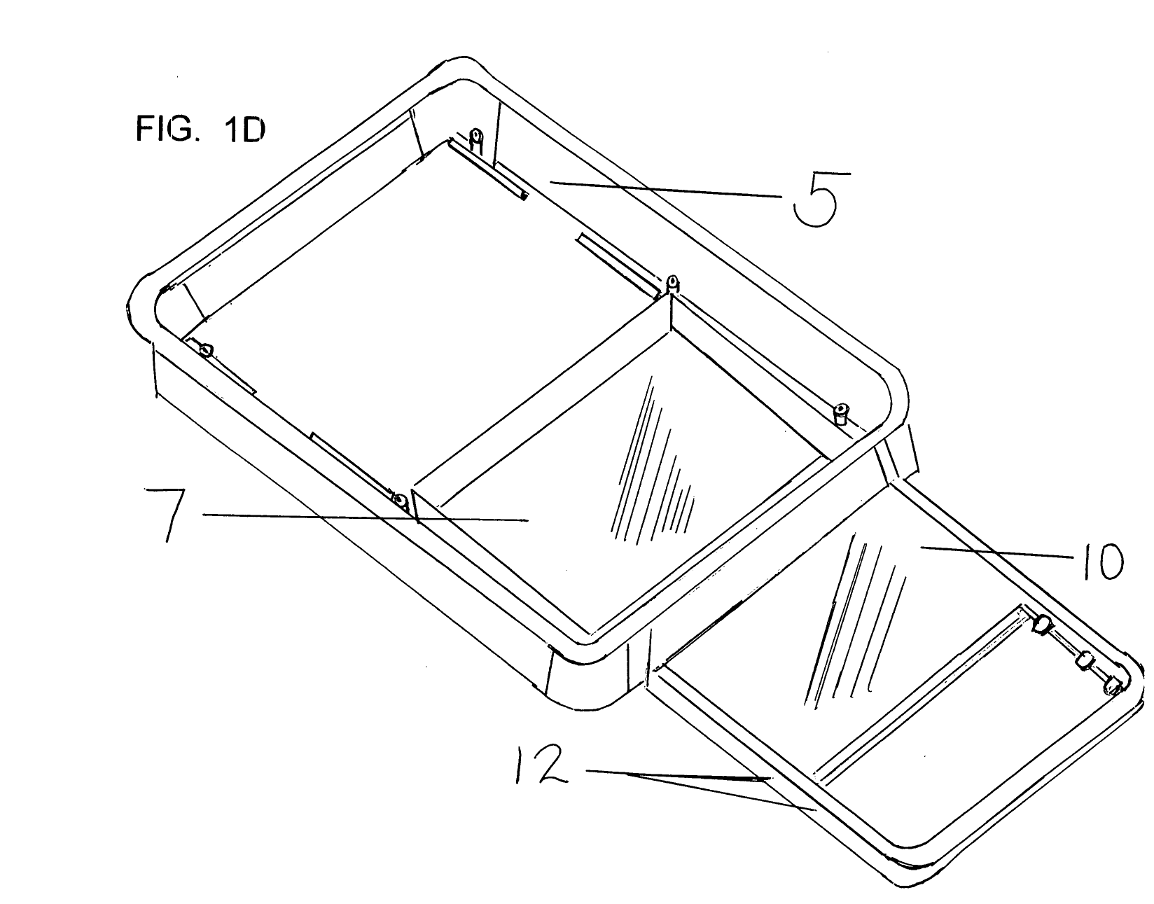

### DETAILED DESCRIPTION—FIGS. 1A, 1B, 1C AND 1D

### Preferred Embodiment

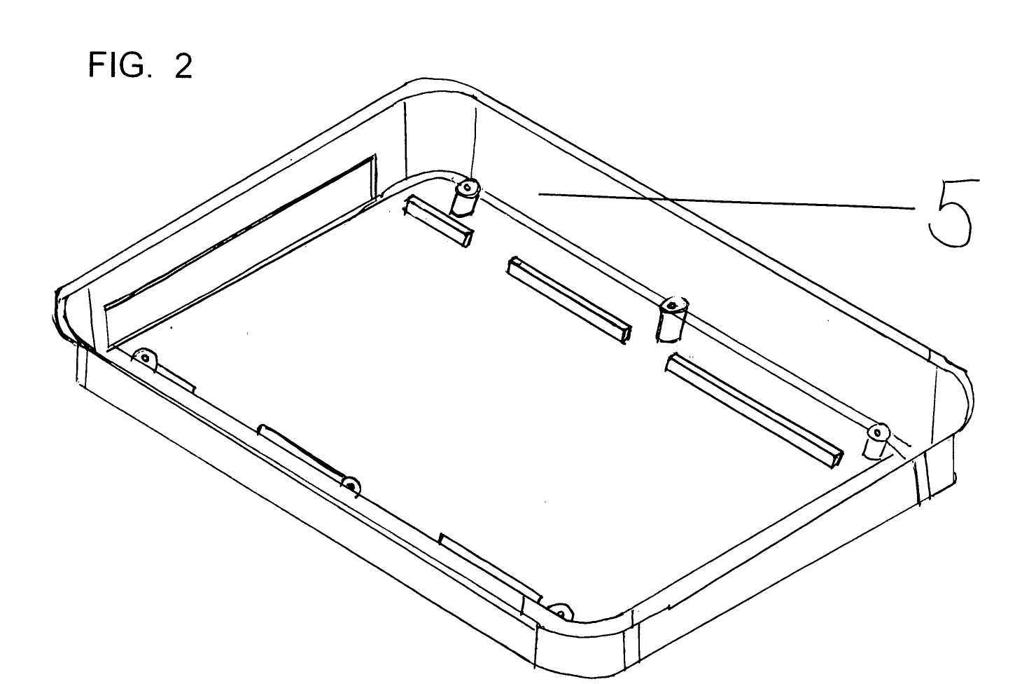

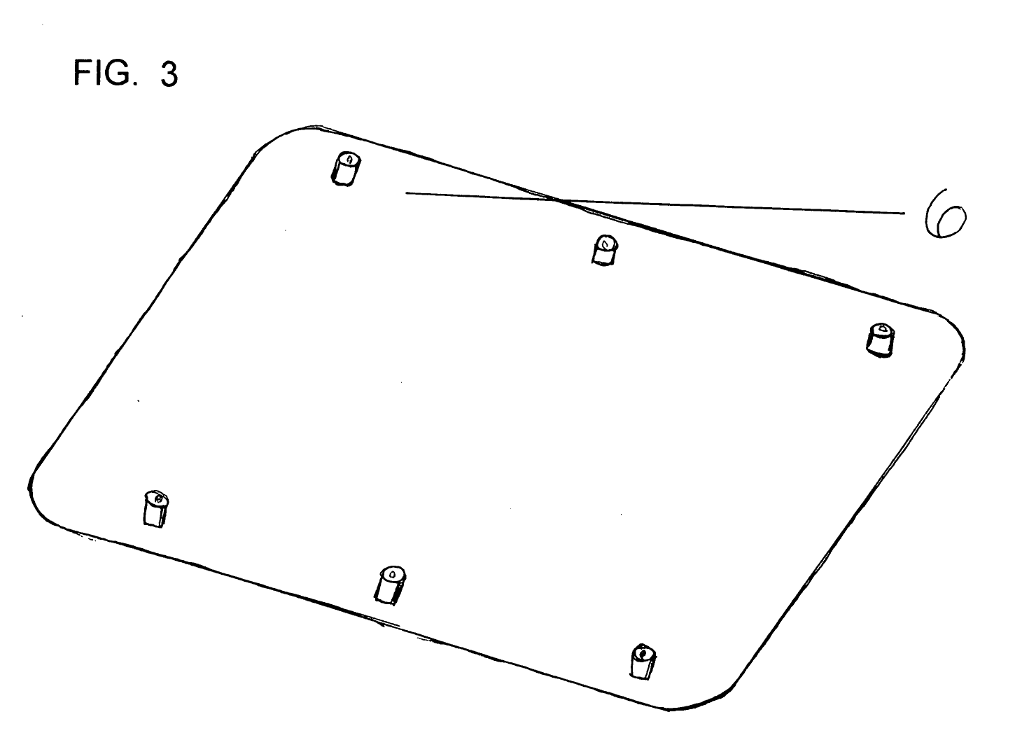

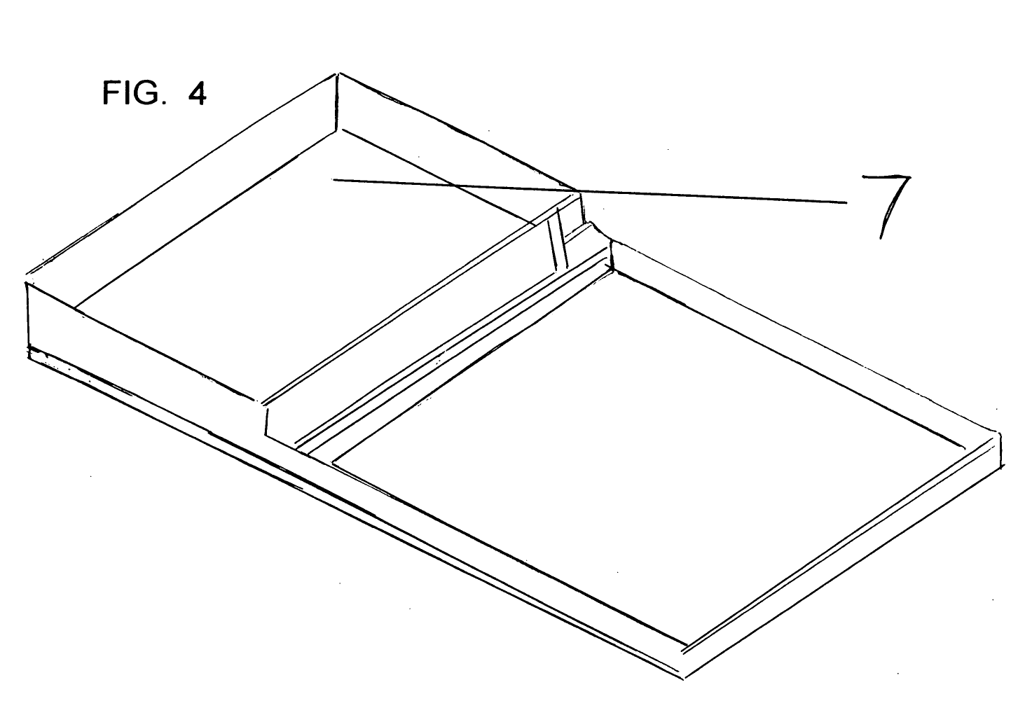

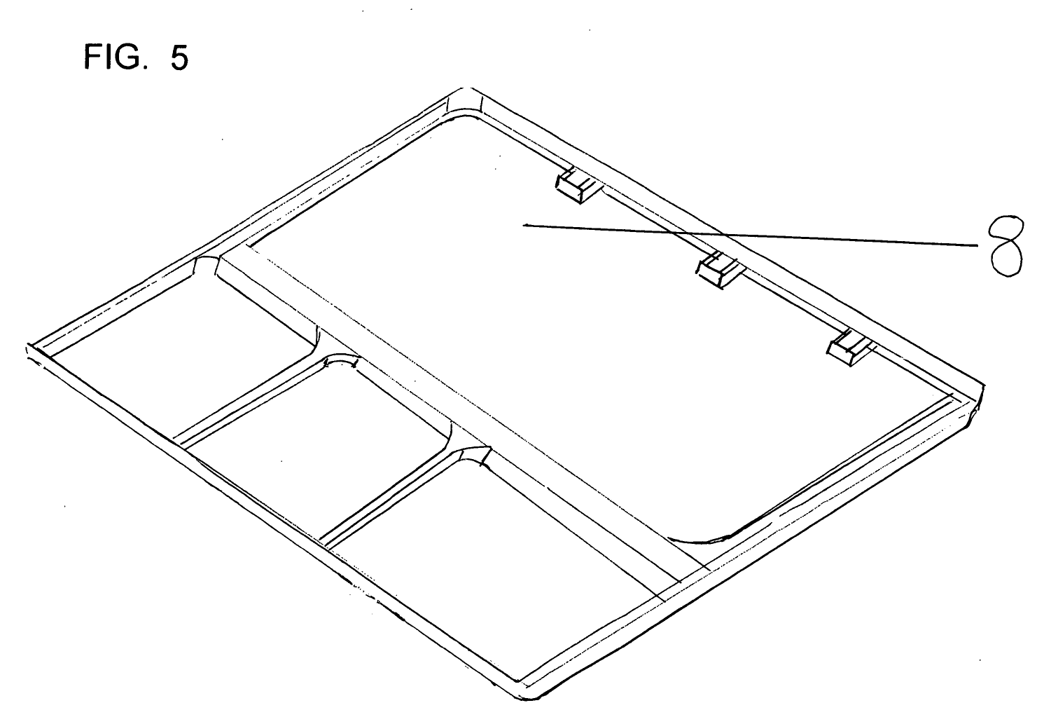

A preferred embodiment of the server's tray of the present invention is illustrated in FIG. 1A (fully assembled view) and FIG. 1B (interior view). The server's tray has enclosed drawers which slide left to right on a slotted track 5 in FIG. 2. Left drawer is an open compartment 7 in FIG. 4. The right side drawer has a landing for removable cash bank 7 in FIG. 4. Top of tray inserts to bottom portion of tray 6 in FIG. 3 and 5 in FIG. 2. Perferred embodiment is made from thermal injected plastic such as HIPS.

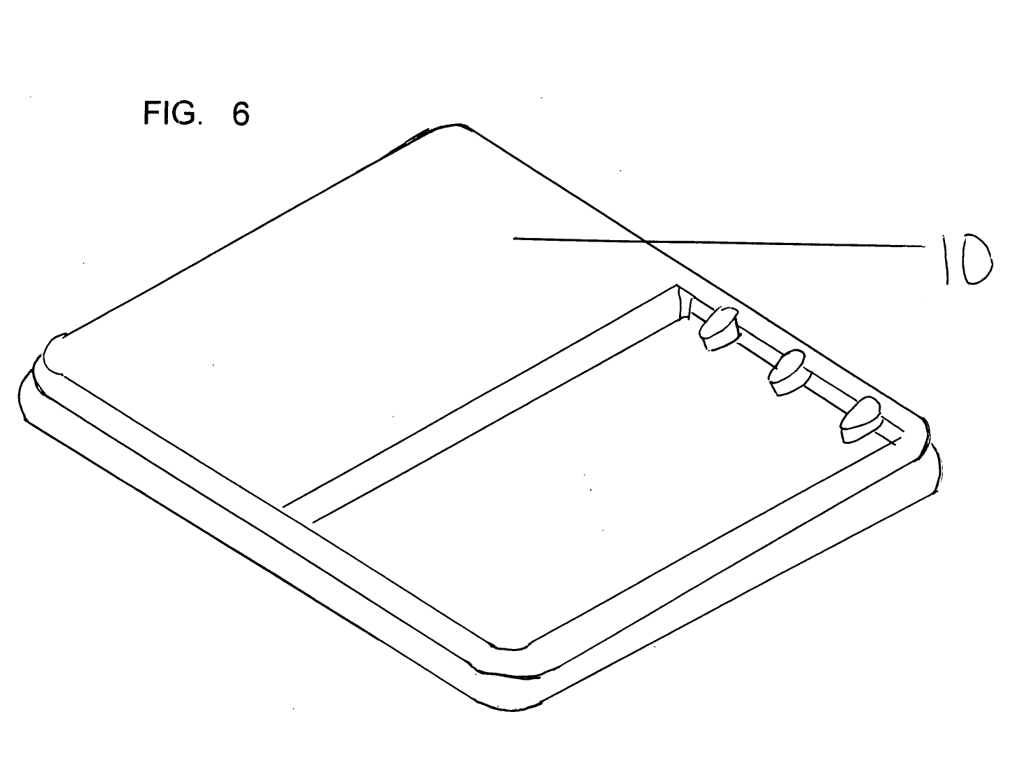

Right drawer has a removable cash bank in FIG. 1C (assembled view) and FIG. 1D (interior exposed). Removable cash bank shows bottom portion of bank with concave areas for coin, paper monies and slots for assembly 8 in FIG. 5. Top part of removable cash bank has an exterior surface which is concave for a notepad insertion and notches to secure notepad 10 in FIG. 6.

Operation—FIGS. 2, 3, 4, 7, 8, 9, 1D

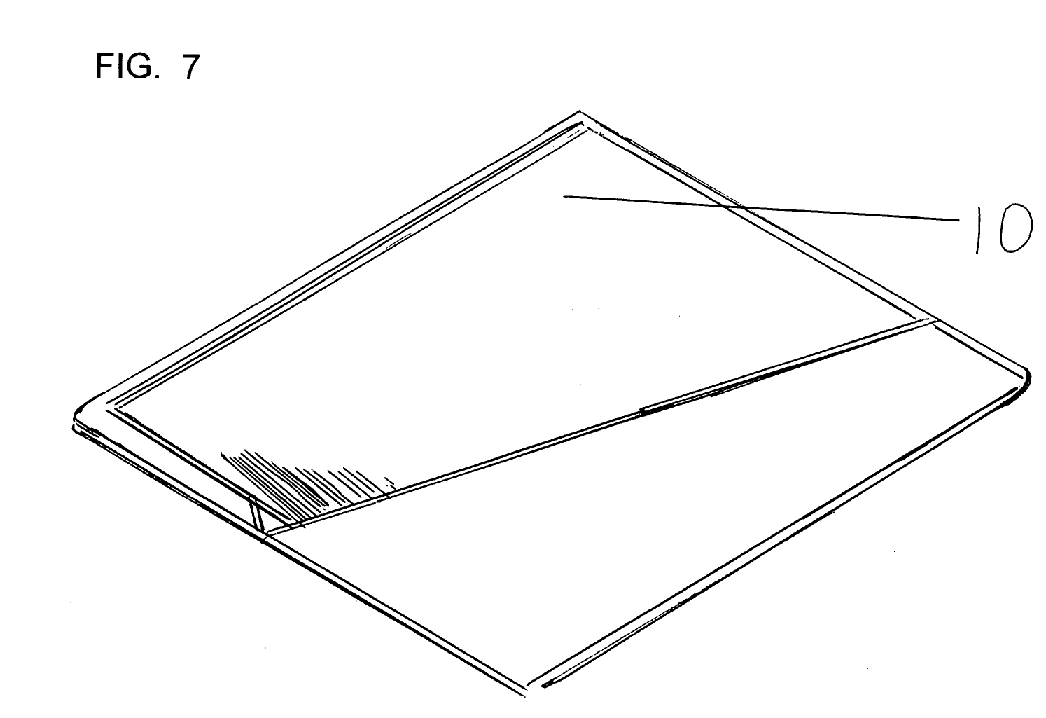

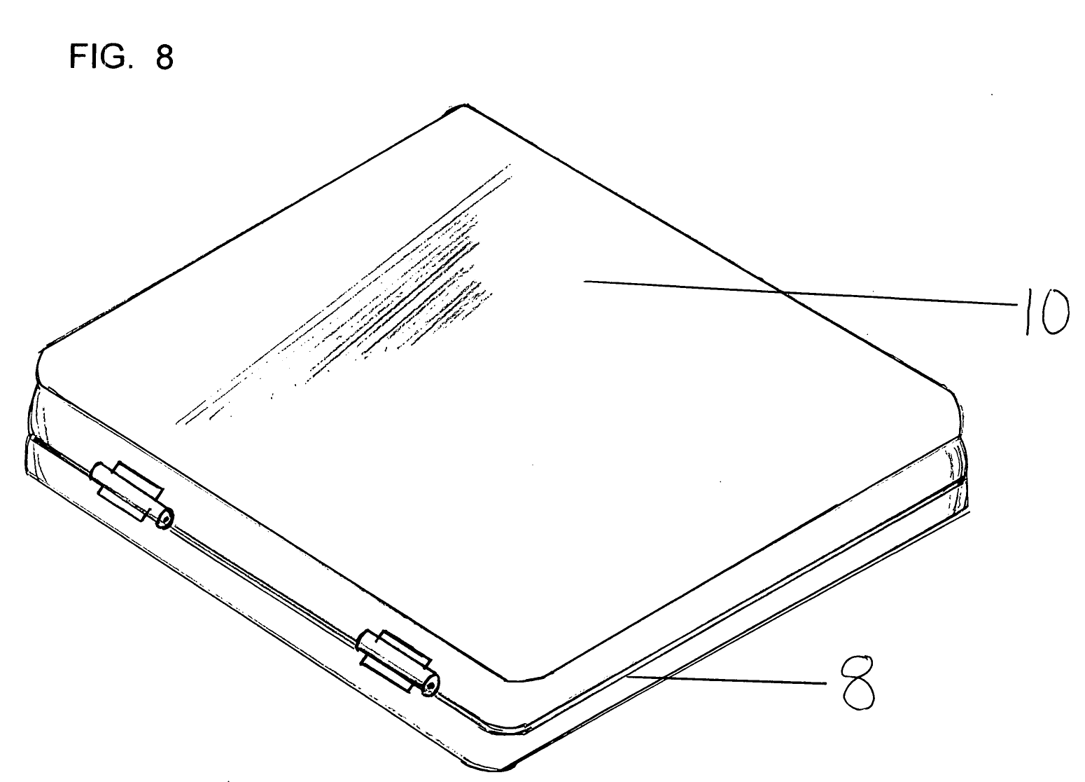

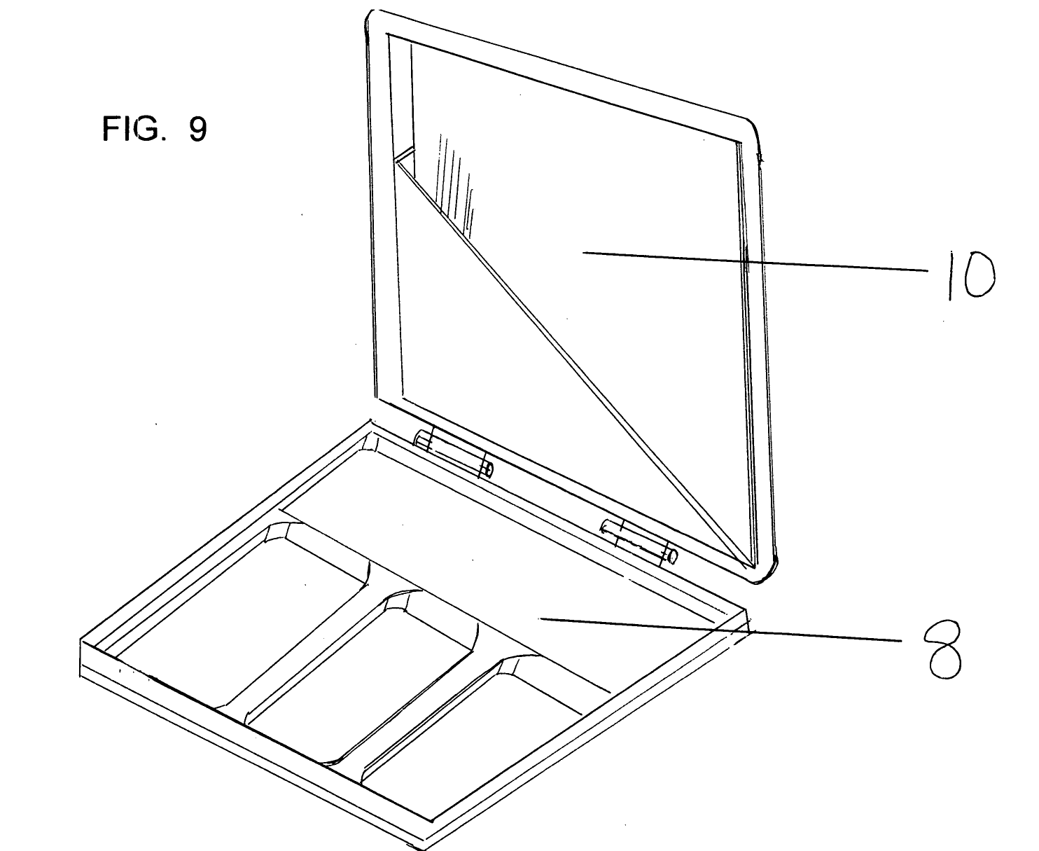

Interior skeleton of servers tray with slotted track for drawers 7 in FIG. 4 and pegs for tray top insertion of 6 in FIG. 3; into receiving pegs of 5 in FIG. 2. Left drawer compartment and right landing for removable cash bank 7 in FIG. 4 are engaged with slotted tracks 5 in FIG. 2. Interior lid of cash bank 9 in FIG. 7 attaches to bottom interior cash bank 11 in FIG. 8. Together top portion of cash bank and bottom portion of cash bank are secured together by hinges 12 in FIG. 9. Closed cash bank is inserted into landing 7 in FIG. 4 and complete in 4 FIG. 1D.

Advantages

From the description above, a number of advantages of my server's tray with enclosed drawers and removable cash bank become evidient:
(a) Enclosed drawers in-board a server's tray allows for more valuable working space on top of the tray.
(b) Light weight and durable thermal injected plastic affords the longevity and strength of the servers tray.
(c) Added space of an open drawer for server accruements, create increased organization and efficiency.
(d) Cash bank securely organizes money transactions.
(e) Exterior upper lid of cash bank houses convienent notepad for server's orders.
(f) Cash bank is easily removed for added security or convience of the server.

### Conclusion, Ramifications and Scope

Accordingly, the reader will see that the server's tray with enclosed drawers and removable cash bank can be used to increase efficiency of service through the enclosed drawers. In addition, the server has increased working space and secure money transactions. Furthermore, the server's tray with enclosed drawers and removable cash bank has the additional advantages:
it provides an immediate solution to the service industry;
it provides more working space and organization for the server's duties;
it permits server's to remove cash bank from service tray for portability;
it provides a secure alcove and slot for note pad, allowing ease of order taking;
it provides a compartment to store supplies and tips.

Although the description above contains many specificities, these should not be construed as limiting the scope of the invention but merely providing illustrations of some of the presently preferred embodiments of this invention. For example, the server's tray can have other shapes such as round or oval; the thermal injected plastic can be made in a multitude of colors and various strengths and durabilities.

Thus, the scope of the invention should be determined by the appended claims and their legal equivalents, rather than by the examples given.

I claim:

1. Server's Tray has enclosed drawers: said drawers are enclosed with in the server tray and operate via a slotted track.

2. Left side drawer is an empty compartment to store pens, tips and supplies.

3. Right side drawer is designed as a means for the removable cash bank.

4. Cash bank is located in the right side drawer; said cash bank is separately inserted as a means for portability of bank.

5. Claim 4 has a slotted coin area and paper money slot.

6. Claim 5 has closable lid to which has an exterior molded alcove.

7. The molded alcove of claim 6 has molded clips formed at the top of said alcove.

8. The molded clips of claim 7 projects outward as a means for a paper notepad.
